(19) United States
(12) Patent Application Publication
(10) Pub. No.: US 2003/0214524 A1
(43) Pub. Date: Nov. 20, 2003

(54) Control apparatus and method by gesture recognition and recording medium therefor

(76) Inventor: Ryuichi Oka, Aizuwakamatsu-shi (JP)

Correspondence Address: PITNEY, HARDIN, KIPP & SZUCH LLP, 685 Third Avenue, New York, NY, 10017, US

(21) Appl. No.: 10/164,723

(22) Filed: Jun. 7, 2002

(30) Foreign Application Priority Data
May 20, 2002 (JP) 2002-144058

(51) Int. Cl. G09G 5/00

(52) U.S. Cl. 345/700; 345/863

(57) ABSTRACT

A gesture recognition unit recognizes a picture of a person's gesture photographed by an image pickup unit, and a control instruction generating unit generates at least one or more control instructions corresponding to the recognition result.

This application is based on Patent Application No. 2002-144058 filed May 20, 2002 in Japan, the content of which is incorporated hereinto by reference.

### BACKGROUND OF THE INVENTION

1. Field of the Invention

The present invention relates to a control apparatus for making a control over something by recognizing a person's gesture photographed by image pickup means, such as a robot, a toy and others.

2. Description of the Related Art

In recent years, the small robots interacting with the person have been developed, and take the similar form to the animals such as a dog and a cat. They may be one kind of toy. For the purpose of using this toy robot, it has been found that this toy robot is effective for mental rehabilitation of the elderly or handicapped person. At present, some toy robots are available on the market. This market is possibly expanded in the future.

At present, means for communication between this toy robot and the person is mainly limited to the person's contact with the robot and addressing in the voice to the robot, as disclosed in Japanese Patent Application Laid-open No. 2002-116794. However, it is extremely important to expand the breadth of communication between the person and the toy robot, which is a crucial technical factor for developing the market of the robots of this kind. Communication means used nowadays that relies on the contact and speech has poor performance, and greater importance is acquired. For example, a contact sensor in which the person makes contact with the robot is only employed to pass the simple information of contact and withdrawal to the limited department, and in the voice, a quite meagre vocabulary of ten words or less can be dealt with.

The input of information by the person's contact with the robot is difficult in the environment where the person can not contact with the robot, for example, the environment of high temperatures or very low temperatures. Also, there is the inconvenience that the input of information by voice is difficult in the environment where the noise occurs.

### SUMMARY OF THE INVENTION

Thus, it is a first object of the present invention to provide a control apparatus and method in which there is less influence from the environment, and a recording medium for use therewith.

It is a second object of the present invention to provide a control apparatus, method and a recording medium capable of registering a new instruction for making a control.

The present invention provides a control apparatus for controlling a control object on the basis of a control instruction, comprising image pickup means for photographing a person's gesture, gesture recognition means for recognizing the sort of a picture of the photographed gesture, and control instruction generating means for generating at least one or more control instructions corresponding to the sort recognized by the gesture recognition means.

In the present invention, the gesture recognition means may have feature analysis means for acquiring a feature of gesture from the gesture picture photographed by the image pickup means by image analysis, whereby the gesture recognition means recognizes the sort of gesture by comparing the feature acquired by the feature analysis means with the features of a plurality of gestures having the sorts known.

Further, in the present invention, the features of gestures having the sorts known can be registered, and the gesture picture photographed by the image pickup means may be analyzed by the feature analysis means to acquire the feature to be registered.

According to the present invention, the control contents can be instructed by gesture, and thus is suitably employed in the noise environment or the environment where the person can not make contact with the apparatus. Also, a new control instruction can be effected by a combination of voice and gesture.

The above and other objects, effects, features and advantages of the present invention will become more apparent from the following description of embodiments thereof taken in conjunction with the accompanying drawings.

### BRIEF DESCRIPTION OF THE DRAWINGS

FIG. 1 is an explanatory view showing a toy robot applying a gesture recognition method;

FIG. 2 is an explanatory view showing a gesture image that is taken by the toy robot;

FIG. 3 is a view for explaining the gesture recognition method;

FIG. 4 is a view for explaining the gesture recognition method;

FIG. 5 is a view for explaining the gesture recognition method;

FIG. 6 is a graph for explaining a registration of a gesture; and

FIG. 7 is a block diagram showing one configuration example of a control apparatus.

### DETAILED DESCRIPTION OF PREFERRED EMBODIMENTS

The preferred embodiments of the present invention will be described below with reference to the accompanying drawings.

(Description of Control Method of Control Apparatus)

A control apparatus will be described below by way of example, by using a toy robot here, but is not limited thereto.

Herein, communication means between the person and the toy robot that is currently most important is provided through the use of a gesture or a motion. In communication, the person works on the robot by a gesture or an action, and in response to it, the robot makes a cry or a movement.

Such a gesture or motion performed by the person is usually employed to interchange one's will with a dog or a cat, in the case where the living dog or cat is kept in the house. For example, the person performs a gesture or motion indicating “Come here”, “Hand”, “Beat”, “Get away”, or “Turn around” in face of the animal to make communication. The present invention principally involves a description of how to append a function of understanding this gesture or motion to the toy robot. The gesture recognition methods of recognizing the gesture or motion are listed below as the well-known literatures disclosed by the inventor of present application.

(1) U.S. Pat. No. 4,989,249 Speech feature extracting method, and recognition method and apparatus

(2) Japanese Patent Application No.5-217566 (1993) [Japanese Patent Application Laid-open No. 7-73289 (1995)] Gesture moving picture recognition method

(3) Japanese Patent Application No.8-47510 (1996) [Japanese Patent Application Laid-open No. 9-245178 (1997)] Gesture moving picture recognition method

(4) Japanese Patent Application No.8-149451 (1996) [Japanese Patent Application Laid-open No. 9-330400 (1997)] Gesture recognition apparatus and method

(5) Japanese Patent Application No.8-322837 (1996) [Japanese Patent Application Laid-open No. 10-162151 (1998)] Gesture recognition method

(6) Japanese Patent Application No.8-309338 (1996) [Japanese Patent Application Laid-open No. 10-149447 (1998)] Gesture recognition method and apparatus

This invention relates to a control apparatus applying the gesture or motion recognition methods. It will be described below.

(Application to a Small Toy Robot)

As the robot's eyes, one or more small CCD cameras are attached to a head of the robot. A moving picture from the camera is captured, and a CPU for learning or recognizing a gesture is built into the robot. Furthermore, the robot is equipped with a function of transforming a gesture recognition result by the CPU into a composite sound uttered by the robot or a body motion of the robot.

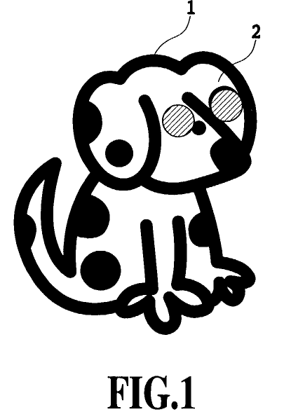

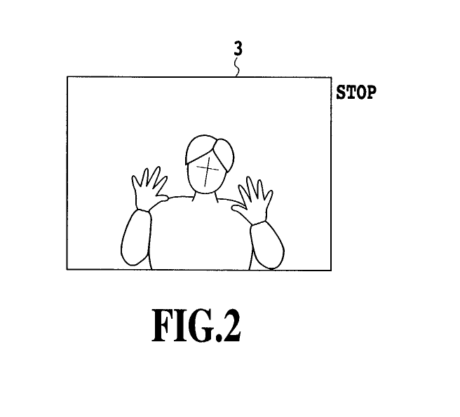

In a small toy robot 1 as shown in FIG. 1, one CCD camera or two CCD cameras are attached at the position of eye or eyes 2, for example. Thereby, a gesture made in front of the robot is captured as a moving picture. The robot captures this gesture through the eyes as an image 3 as shown in FIG. 2. This gesture is recognized only if a time series of registered gestures for an interval appears in the moving picture provided in series. When the number of sorts of gestures to be recognized is twelve, the result of what is recognized at present time is represented in characters as indicated at the right upper part of FIG. 2. Herein, if the movement of the robot in response to the result of gesture recognition is decided in advance, the interaction between the person and the robot is implemented through the use of gesture, when the robot performs that movement.

For example, in a case where the person makes a gesture of “Stop”, the motion of that gesture is recognized, a recognition code of “Stop” is passed to a movement system of the robot for travelling or shaking the head, so that the movement of travelling or shaking the head is stopped.

Similarly, assuming that an interval time series of moving picture for a gesture movement of moving the hand to the left or right has a meaning of “move”, (which can be registered online in a simple manner), when the person makes this movement, the camera observes it as a moving picture, and recognizes the movement, namely, obtains a recognition code of “Move”, whereby the recognition code is passed to a robot drive system, which drives the robot, if not being moved.

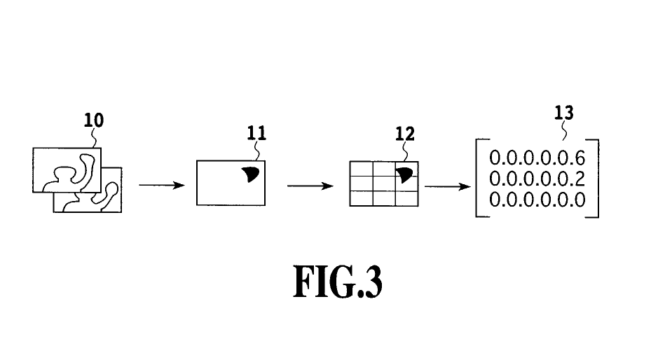

By the way, in a situation where the toy robot is moving, there occurs a problem that while any person residing around the robot makes a gesture, the robot can recognize the gesture favorably or not. That is, a stubborn unbending gesture recognition method is required in this situation. To obtain this stubbornness, it is important for one thing to be stubborn in extracting the features from the moving picture. Specifically, it is necessary to recognize the gesture movement in a temporal stream. For this purpose, it is recommended to use the gesture recognition method as proposed in Japanese Patent Application No.8-322837 (1996) [Japanese Patent Application Laid-open No. 10-162151 (1998)]. This method is shown in FIG. 3.

In FIG. 3, a temporal differential value of image data of a plurality of continuous still images, namely, adjacent two still images in a so-called moving picture 10 is calculated by an information processor such as a CPU. The temporal differential value is a difference between the values of image data for the same pixel at two different times. The differential value may or may not be greater than a threshold value, a greater value is represented by bit “1”, and a smaller value is represented by bit “0”. In this manner, the differential value is binarized, and the distribution of bit value corresponding to the pixel position is denoted by numeral 11. The bit distribution at numeral 11 represents the feature of gesture. To represent the feature of gesture in numerical value, a distribution area (corresponding to the screen) at numeral 11 is divided into a plurality of areas. The number of bit “1” in the divided areas is counted and set up as the feature value of gesture in one still image. The feature values of a plurality of continuous still images constitute what is called a feature pattern of gesture. Numeral 13 denotes a matrix indicating the number of bit “1” in each divided area. If the matrix is reduced to about 2×2 by using this recognition method, the stubborn gesture recognition can be effected.

Moreover, there occurs another problem with the number of gestures to be recognized in reducing the resolution. In the resolution of FIG. 3, the number of gestures to be recognized is limited to 40 kinds, but for the toy robot, 10 kinds or less of gestures are needed. Therefore, the amount of feature from the image of each frame is needed by 2×2.

Further, there occurs another problem with the timing of gesture. If the gesture is not accepted without specific command, the practical constraint is too strong.

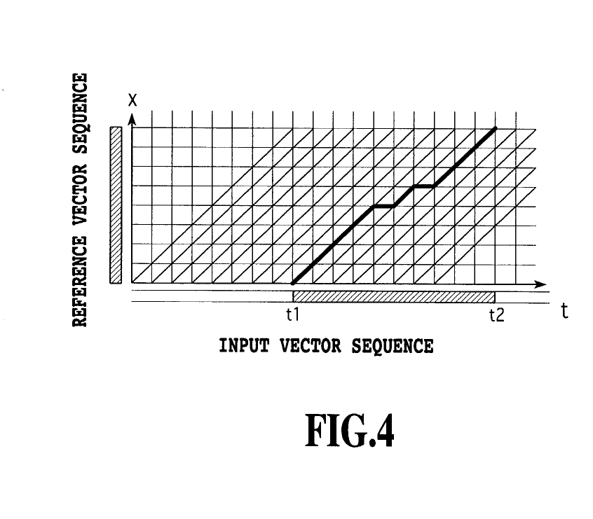

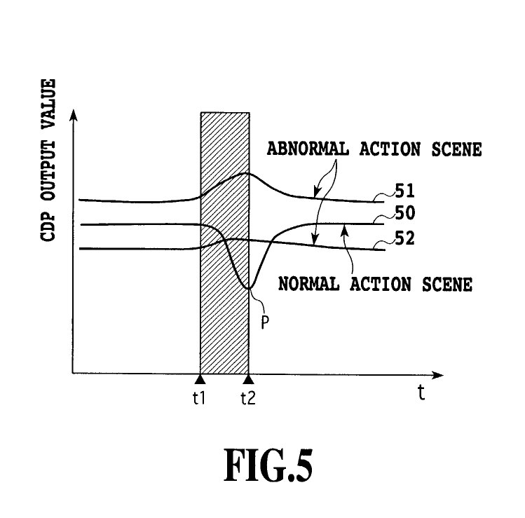

However, by using a matching method that is referred to as a continuous DP as disclosed in Japanese Patent Application No.8-149451 (1996) [Japanese Patent Application Laid-open No. 9-330400 (1997)] or Japanese Patent Application No.8-322837 (1996) [Japanese Patent Application Laid-open No. 10-162151 (1998)], this constraint can be removed. FIGS. 4 and 5 show a gesture recognition method using the matching method with the continuous DP. In FIG. 4, the longitudinal axis is a reference vector sequence, or what is called a standard pattern for one gesture. This standard pattern is a feature pattern acquired by the method of FIG. 3. The transverse axis is an input time series pattern (input vector sequence), which has no mark indicating the start and the end. For easier understanding, the feature values continuously acquired from a photographed image of gesture to be recognized by the method of FIG. 3 is the transverse axis (input vector sequence).

The distance (referred to as a CDP) between the input vector sequence and the reference vector sequence from the time t1 to time t2 is calculated by the continuous DP (dynamic programming), in which its calculation result becomes a CDP output value at time t2 in FIG. 5. If the distance is calculated over the time, a CDP output distribution is obtained as shown in FIG. 5. In the case where the input vector sequence of recognition object is the same gesture as the reference vector sequence, an output distribution 50 is obtained, or otherwise, an output distribution 51 or 52 is obtained.

In the case of the same gesture, the output distribution has a characteristic that the output value is lower than the threshold as indicated by sign P in FIG. 5.

The reference vector sequences corresponding to a plurality of kinds of gestures are prepared in a memory within the robot, and compared with the input vector sequence obtained from the result photographed by the CCD under the control of the CPU, whereby the recognition result is the gesture indicated by the reference vector sequence having the point P. The recognition result can be obtained in the form of identification information indicating the kind of reference gesture.

This matching method can handle the continuous still images as recognition object, whereby a situation is permitted in which the data is entered without intermittence while the video camera is switched on. In this state, at the moment the person performs a gesture in the field of view of the camera for the robot, the result can be output momentarily if the gesture is registered.

Though this continuous DP has one output in one standard pattern, if this value is locally smaller, it is determined that a similar gesture to the corresponding standard pattern exists. At this time, the continuous DP value is not decreased if the gesture is registered but does not exist in the input. In FIG. 5, the outputs of three standard patterns are represented, in which one of them is matched and has a smaller continuous DP value. Even though the camera captures the gesture without intermission, and the person repeats the gesture without cease, the continuous DP value is not decreased unless the person performs the registered gesture. This means that there is no need of designating the timing when the user performs the gesture, whereby the user has extremely small burden, and makes a natural gesture. Such a way of use has possibly a quite important function, considering that the toy robot is employed for the child or elderly or handicapped person. In this sense, a software implemented in the toy robot is very powerful in its availability.

Next, a second embodiment in which the person teaches the robot by gesture online will be described. The person has a variety of demands for making the robot behave to the person's intention, namely, instructing how the robot makes the movement, if the person makes the gesture of which meaning in what way. Even though the meanings of “Beckon” and “Hands up!” are deterministic, the person has own personality to represent them by gesture. In such an actual use condition, it is an extremely important function that the person can bestow a gesture of new meaning and its movement at the site. Thus, this function is implemented in the following way.

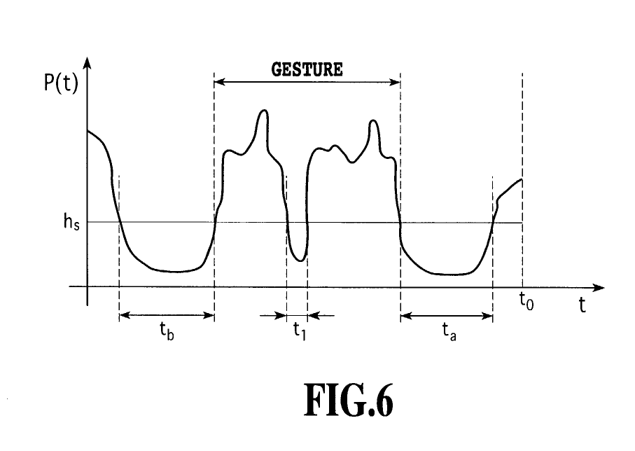

First of all, a list of motions permitted for the robot is prepared. Then, the robot is made to utter a composite voice to represent the contents of this movement. For example, the robot utters a voice of “Beckon”. Thereafter, the person makes a gesture of “Beckon”. Then, this gesture is registered as a time series of moving picture. Referring to FIG. 6, this registration method will be described below. It is assumed now that the sum of numerical values of moving picture feature vectors is denoted by P(t).

If the value of P(t) is higher than a certain threshold, and there is a preceding or succeeding interval in which the value is lower than the threshold, a feature time series of moving picture in an interval where the value of P(t) is higher than the threshold is registered. By this registration, the gesture representing the contents uttered by the robot in the voice is registered. After registration, if the person makes a similar gesture to the registered gesture, it is recognized. Also, if the movement uttered in the composite voice is performed by the robot, the robot makes the movement when it is instructed by gesture. In this manner, the interaction between the robot and the person by gesture is made.

In the above technique, the moving picture has been discussed as the reference pattern. However, when the gesture is indicated in a still state, or when the meaning is represented by using the rock, paper or scissors in the game of “rock-paper-scissors” or raising one finger or two fingers, for example, the gesture of still type can be applied, because the time series in still state are dealt with as the moving picture.

The application to the toy robot has been described above, but in a similar way, the number calling in the portable telephone can be made by gesture, for example. Since the portable telephone has a camera for taking a latest image, this function is easily implemented.

For instance, in the case where there is a desire for calling the son A, a message of “How to call the son A” is uttered in composite tone from the portable telephone. The portable telephone is carried by one hand and a gesture is made by the other hand to instruct the correspondence between the son A and the gesture. In this manner, the number can be called, without depressing the number or the one-touch button, if the number is instructed by the number of distinguishable gestures.

Also, the functions of making various operations by depressing the buttons, such as disconnecting the portable telephone, can be instructed by gesture motion in the same way. Furthermore, the handicapped person or patient, who can not utter a voice, is enabled to pass one's will by gesture of one hand with the same configuration.

In this manner, when it is troublesome or impossible to utter a voice or perform a button operation, an instruction by gesture is more easily made to pass one's will by utilizing the technique as above described.

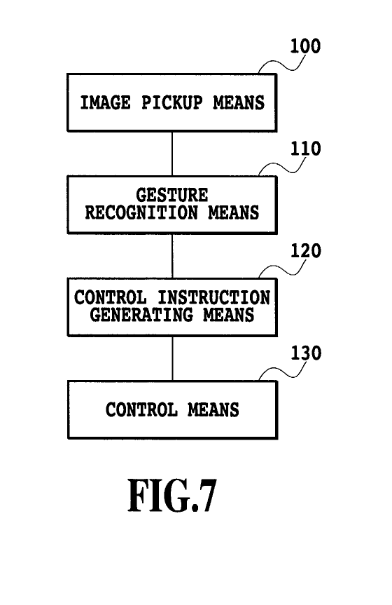

FIG. 7 shows a hardware configuration of the control apparatus applying the gesture recognition method.

In FIG. 7, reference numeral 100 denote image pickup means for photographing a person's gesture, which may be an apparatus for converting an optical image into an image signal, such as a CCD camera or a video camera. The image pickup means 100 is well-known and suitably used, depending on the size of the control apparatus or the use environment.

Reference numeral 110 denotes gesture recognition means, which may be a digital processor or a CPU. With the above gesture recognition method, the digital processor or the CPU executes a program for recognizing a gesture image photographed by the image pickup means 100 to make the gesture recognition. Reference numeral 120 denotes control instruction generating means that generates a control instruction corresponding to the gesture on the basis of the recognition result of the gesture recognition means.

The simplest way of creating a control instruction is a table conversion. One data set is made up of at least one or more control instructions corresponding to one kind of gesture, and a plurality of data sets corresponding to a plurality of kinds of gestures are described in the table. If the recognition result of gesture is obtained, the data set corresponding to the recognition result is taken out to create the control instruction given to the control means 130.

Another method involves using the function, instead of the table. For the control instruction generating means 120, the digital processor or the CPU may be employed, or the memory called a look-up table may be used.

Reference numeral 130 denotes control means, which may be a circuit for controlling an actuator or a motor of the robot on the basis of the control instruction. The control means is also called a driver, which is conventionally well known, and is not described in detail.

Communication means is suitably provided to connect each means according to an embodiment of the invention. In case of the robot in the service form, each means is connected by a signal line. In case of aportable telephone with CCD camera to make the remote control in the service form, the gesture image photographed by the CCD camera is communicated to the control apparatus main unit via the telephone line.

In the service forms of this invention, the toy robot and the industrial robot may be included. Moreover, this invention is also applicable to other electronic devices or the portable telephone with CCD camera for the remote control (a variety of kinds of electric appliances are controlled).

In the case where the feature of the gesture image photographed by the image pickup means 100 is registered by gesture recognition means 110, the following procedure is performed. The gesture recognition means 120 extracts the feature from the gesture image (moving picture) photographed by the image pickup means 100 in accordance with the method of FIG. 3. Accordingly, the extracted feature is registered in the memory, whereby the feature of gesture usable for recognition of the kind can be newly registered. Therefore, a speech for guiding the gesture to be registered may be output by voice synthesizing means (that is implemented by the use of a well-known voice synthesizing program to be executed by the CPU). Instead of using the speech synthesizing means, image display means such as a display may be employed to indicate the message in the character string form.

In the case where the gesture recognition means 110 and the control instruction generating means 120 are implemented by means for executing the program such as the CPU, its execution program may be stored in the storage medium. The storage medium may be an IC memory, a hard disk, a floppy disk, or a CDROM or the like.

The present invention has been described in detail with respect to preferred embodiments, and it will now be apparent from the foregoing to those skilled in the art that changes and modifications may be made without departing from the invention in its broader aspects, and it is the intention, therefore, in the appended claims to cover all such changes and modifications as fall within the true spirit of the invention.

What is claimed is:

1. A control apparatus for controlling a control object on the basis of a control instruction, comprising:
image pickup means for photographing a person's gesture;
gesture recognition means for recognizing a sort of a picture of said photographed gesture; and
control instruction generating means for generating at least one or more control instructions corresponding to the sort recognized by said gesture recognition means.

2. The control apparatus as claimed in claim 1, wherein said gesture recognition means has feature analysis means for acquiring a feature of gesture from said gesture picture photographed by said image pickup means by image analysis, whereby said gesture recognition means recognizes the sort of gesture by comparing the feature acquired by said feature analysis means with the features of a plurality of gestures having the sorts known.

3. The control apparatus as claimed in claim 2, wherein the features of gestures having the sorts known can be registered, and the gesture picture photographed by said image pickup means is analyzed by said feature analysis means to acquire the feature to be registered.

4. A control method of controlling a control object on the basis of a control instruction, comprising steps of:
photographing a person's gesture by image pickup means;
recognizing a sort of a picture of said photographed gesture by an information processor; and
generating at least one or more control instructions corresponding to the recognized sort by said information processor.

5. The control method as claimed in claim 4, wherein said information processor acquires a feature of gesture from said gesture picture photographed by said image pickup means by image analysis, and recognizes the sort of gesture by comparing the feature acquired by feature analysis with the features of a plurality of gestures having the sorts known.

6. The control method as claimed in claim 5, wherein the features of gestures having the sorts known can be registered in said information processor, and the gesture picture photographed by said image pickup means is analyzed by said feature analysis to acquire the feature to be registered.

7. A recording medium storing a program to be executed on a control apparatus for controlling a control object on the basis of a control instruction,
wherein said program comprises:
a gesture recognition step of recognizing a sort of a gesture picture photographed by image pickup means for photographing a person's gesture; and
control instruction generating step of generating at least one or more control instructions corresponding to the sort recognized at said gesture recognition step.

8. The recording medium as claimed in claim 7, wherein said gesture recognition step comprises a feature analysis step of acquiring a feature of gesture from said gesture picture photographed by said image pickup means by image analysis, thereby recognizing the sort of gesture by comparing the feature acquired by said feature analysis means with the features of a plurality of gestures having the sorts known.

9. The recording medium as claimed in claim 8, wherein the features of gestures having the sorts known can be registered, and the gesture picture photographed by said image pickup means is analyzed at said feature analysis step to acquire the feature to be registered.
